(19) United States
(12) Patent Application Publication
(10) Pub. No.: US 2023/0315716 A1
(43) Pub. Date: Oct. 5, 2023

(54) MANAGING TENANCY UNITS IN A MULTI-TENANCY HYBRID-CLOUD OR ON-PREMISE ENVIRONMENT

(71) Applicant: Bytebase Limited, Hong Kong (CN)

(72) Inventors: Danqing Xu, HONG KONG (CN); Tianzhou Chen, Hong Kong (CN)

(73) Assignee: Bytebase Limited, Hong Kong (CN)

(21) Appl. No.: 17/709,586

(22) Filed: Mar. 31, 2022

(51) Int. Cl. G06F 16/23; G06F 16/21

(52) U.S. Cl. CPC G06F 16/2365; G06F 16/2358; G06F 16/211

(57) ABSTRACT

This application relates to systems, methods, devices, and other techniques for a novel method of managing tenancy units in a multi-tenancy hybrid-cloud or on-premise environment.

### BACKGROUND OF THE INVENTION

This application relates to systems, methods, devices, and other techniques for a novel method of managing tenancy units in a multi-tenancy hybrid-cloud or on-premise environment. Here, A tenancy unit is an isolation unit consisting of database, application, database schema, application configuration, network configuration for each tenant.

Systems, methods, devices, and other techniques for managing tenancy units in a multi-tenancy hybrid-cloud or on-premise environment are not yet available.

Therefore, it is desirable to have systems, methods, devices, and other techniques for a novel method of managing tenancy units in a multi-tenancy hybrid-cloud or on-premise environment.

### SUMMARY OF THE INVENTION

This application relates to systems, methods, devices, and other techniques for a novel method of managing tenancy units in a multi-tenancy hybrid-cloud or on-premise environment.

In general, one of the methods is related to managing and updating tenancy units for multi-tenant applications and databases.

Multi-tenancy is an architecture where a single or a few instances of software and their supporting infrastructure serves multiple tenants (customers). This is different from multi-single-tenant architecture where each tenant gets its own copy of the software and infrastructure. A service provider runs a shared infrastructure consisting of one or a few copies of software or instances (database instances). Each copy of software (e.g. database instance) can provide many isolation units named as tenancy units (e.g. databases). A tenancy unit is an isolation unit consisting of database, application, database schema, network configuration, application configuration, for each tenant. The service provider can assign these tenancy units and offer multi-tenant SaaS services to each of their tenants by sharing the same infrastructure or set of resources. However, their tenants are isolated from each other. There is a single management service managing all tenancy units consisting of applications or databases for all tenants.

An example is that an accounting firm stores sensitive financial records for each tenant (customer is a company) in each database. These databases can be provided by a single or a few database instances, or even database instances running in customer's on-premise data center for security reasons.

Management of tenant operations in the above example includes creating a tenancy unit (database, application) for each company as a separate tenant; updating the tenancy unit (database, application) or the configuration of a unit (database schema, application configuration, network configuration) for a tenant; deleting the tenancy unit (database) for a tenant; and communication between management service and tenancy unit. For example, the possible action includes database backup, application internal API update and IT support.

Another method related to the invention is coordinating application and database updates for multi-tenancy units.

The management service of coordinating application and database updates for multi-tenancy units, or an update manager service, is responsible for updating the tenancy units including application/network configurations, databases/database schemas for all tenants. The updates should be divided into stages to achieve high overall reliability for all tenants. For example, non-production tenants should be updated before production tenants; updates to tenancy units in multi-region infrastructure should be done region by region. If any unexpected failure happens, the update should be paused and rolled back.

Another method related to the invention is managing and updating tenancy units in a multi-tenancy hybrid-cloud or on-premise environment. Networking connection is usually restricted in hybrid-cloud or on-premise (data center from clients) environments and such environments can only initiate outbound network connection and can't accept inbound network connection requests. There should be a service agent in each tenancy unit connecting to the management service and receiving messages of instructions asynchronously. The updates sent by the management service are versioned and can be canceled/rolled back upon failures. The agents will receive updates in order and perform actual updates on the tenancy units including applications, network configurations, databases, or database schemas.

In some embodiments, the invention related here is a method of managing tenants and tenancy units. In some embodiments, the method comprises a step of receiving a first request from a first requester to create a first tenant.

In some embodiments, the method comprises a step of creating a first tenancy unit with the first tenant, wherein the first tenant is configured to provision its applications and databases, wherein the first tenancy unit is configured to be a first isolation unit consisting of database, application, database schema, application configuration, for the first tenant.

In some embodiments, the method comprises a step of receiving at least another request from at least another requester to create at least another tenant.

In some embodiments, the method comprises a step of creating at least another tenancy unit with the at least another tenant, wherein the at least another tenant is configured to provision its applications and databases, wherein the at least another tenancy unit is configured to be at least another isolation unit consisting of database, application, database schema, application configuration, network configuration, for the at least another tenant; wherein the first tenancy unit and the at least another tenancy run the same application, same database schema, and same application configuration template, wherein all tenants comprise the first tenant and the at least another tenant, wherein all tenancy units comprises the first tenancy unit and the at least another tenancy unit.

In some embodiments, the method comprises a step of receiving a request from a third requester to update the first tenant and the at least another tenant

In some embodiments, the method comprises a step of instructing all tenancy units to use a new version of application, application configuration, network configuration, database schema, or tenancy unit data and database backup or restore, or perform other instructions.

In some embodiments, the method comprises a step of receiving a request from a fourth requester to delete a certain tenant of all tenants, wherein the certain tenant has a certain tenancy unit.

In some embodiments, the method comprises a step of deleting the certain tenancy unit for the certain tenant.

In some embodiments, the invention related here is a method of coordinating application and database updates for multi-tenancy units of all tenants. In some embodiments, the method comprises a step of defining tenant deployment schedule and strategy for any development cycle of the all tenants, wherein the development cycle consists of any combination of a set of environments: development, sandbox, testing, integration, staging, canary and production.

In some embodiments, the method comprises a step of receiving a request from a requester to update applications and databases for any of the deployment cycle.

In some embodiments, the method comprises a step of instructing the multi-tenancy units to follow the defined deployment schedule and strategy, wherein the defined deployment and strategy includes updating the multi-tenancy units in the order of development cycles.

In some embodiments, the method comprises a step of checking versions of all tenants.

In some embodiments, the method comprises a step of flagging an unexpected failure, if more than one version exists for all tenants when there is no update, or no more than two versions of tenancy units exist when an update is being executed to the all tenants.

In some embodiments, the method comprises a step of pausing and rolling back updates to all tenants when the unexpected failure occurs.

In some embodiments, the invention related here is a method of managing and updating tenancy units in a multi-tenancy hybrid-cloud or on-premises environment. In some embodiments, the method comprises a step of running a service agent application in each tenancy unit of all tenancy units, wherein the service agent application is configured to connect or perform actual actions to the applications or databases in a multi-tenancy hybrid-cloud or on-premises environment.

In some embodiments, the method comprises a step of publishing instruction messages to all tenancy units by a management service, wherein the instruction messages are not sent to the all tenancy units via network directly, wherein the instruction messages are queued for the service agent application to query, wherein the service agent application is configured to connect to the management service and receive instruction messages asynchronously, wherein the updates are received in versioned order.

In some embodiments, the method comprises a step of performing actual actions on the all tenancy units by the service agent application including updates to applications, application configurations, network configurations, databases, database schemas, or agent itself, or tenancy unit data and database backup or restore.

In some embodiments, the method comprises a step of acknowledging the completion of the actual actions.

In some embodiments, the method comprises a step of leaving a marking, wherein the marking is successful if the execution of the updates as completed, wherein the marking is failed if the execution is failed or timed-out.

### BRIEF DESCRIPTION OF THE DRAWINGS

FIG. 1 shows an example of a method of managing tenants and tenancy units

FIG. 2 shows an example of a method of coordinating application and database updates for tenancy units of all tenants.

FIG. 3 shows a method of managing and updating tenancy units in a multi-tenancy hybrid-cloud or on-premises environment.

### DETAILED DESCRIPTION OF THE INVENTION

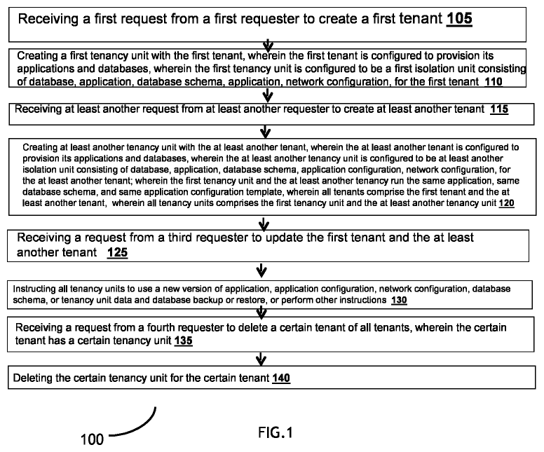

FIG. 1 shows an example of a method 100 of managing tenants and tenancy units.

In some embodiments, the method comprises a step 105 of receiving a first request from a first requester to create a first tenant;

In some embodiments, the method comprises a step 110 of creating a first tenancy unit with the first tenant, wherein the first tenant is configured to provision its applications and databases, wherein the first tenancy unit is configured to be a first isolation unit consisting of database, application, database schema, application configuration, for the first tenant;

In some embodiments, the method comprises a step 115 of receiving at least another request from at least another requester to create at least another tenant;

In some embodiments, the method comprises a step 120 of creating at least another tenancy unit with the at least another tenant, wherein the at least another tenant is configured to provision its applications and databases, wherein the at least another tenancy unit is configured to be at least another isolation unit consisting of database, application, database schema, application configuration, network configuration, for the at least another tenant; wherein the first tenancy unit and the at least another tenancy run the same application, same database schema, and same application configuration template, wherein all tenants comprise the first tenant and the at least another tenant, wherein all tenancy units comprises the first tenancy unit and the at least another tenancy unit;

In some embodiments, the method comprises a step 125 of receiving a request from a third requester to update the first tenant and the at least another tenant;

In some embodiments, the method comprises a step 130 of instructing all tenancy units to use a new version of application, application configuration, network configuration, database schema, or tenancy unit data and database backup or restore, or perform other instructions;

In some embodiments, the method comprises a step 135 of receiving a request from a fourth requester to delete a certain tenancy unit of a tenant, wherein the certain tenant has a certain tenancy unit.

In some embodiments, the method comprises a step 140 of deleting the certain tenancy unit for the certain tenant.

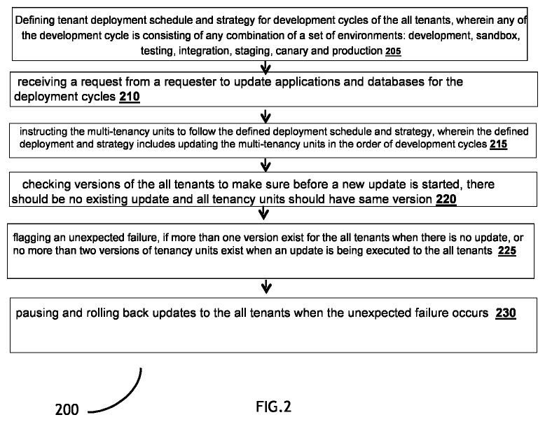

FIG. 2 shows an example of a method 200 of coordinating application and database updates for multi-units of all tenants.

In some embodiments, the method comprises a step 205 of defining tenant deployment schedule and strategy for development cycles of the all tenants, wherein any of the development cycles is consisting of any combination of a set of environments: development, sandbox, testing, integration, staging, canary and production.

In some embodiments, the method comprises a step 210 of receiving a request from a requester to update applications and databases for any of the deployment cycles.

In some embodiments, the method comprises a step 215 of instructing the multi-tenancy units to follow the defined deployment schedule and strategy, wherein the defined deployment and strategy includes updating the multi-tenancy units in the order of the development cycles;

In some embodiments, the method comprises a step 220 of checking versions of the all tenants to make sure before a new update is started, there should be no existing update and all tenancy units should have same version.

In some embodiments, the method comprises a step 225 of flagging an unexpected failure, if more than one version exist for the all tenants when there is no update, or no more than two versions of tenancy units exist when an update is being executed to the all tenants; and

In some embodiments, the method comprises a step 230 of pausing and rolling back updates to all tenants when the unexpected failure occurs.

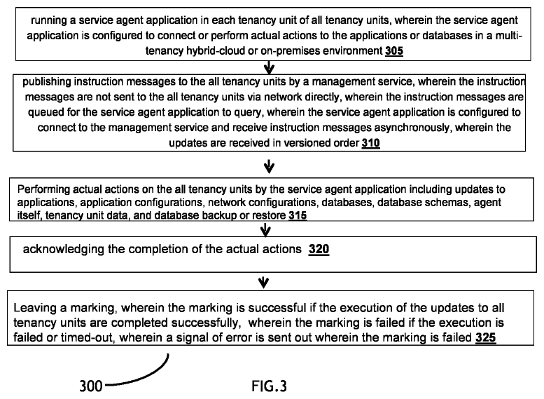

FIG. 3 shows an example of a method 300 of managing and updating tenancy units in a multi-tenancy hybrid-cloud or on-premises environment.

In some embodiments, the method comprises a step 305 of running a service agent application in each tenancy unit of all tenancy units, wherein the service agent application is configured to connect or perform actual actions to the applications or databases in a multi-tenancy hybrid-cloud or on-premises environment.

In some embodiments, the method comprises a step 310 of publishing instruction messages to the all tenancy units by a management service, wherein the instruction messages are not sent to the all tenancy units via network directly, wherein the instruction messages are queued for the service agent application to query, wherein the service agent application is configured to connect to the management service and receive instruction messages asynchronously, wherein the updates are received in versioned order.

In some embodiments, the method comprises a step 315 of Performing actual actions on the all tenancy units by the service agent application including updates to applications, application configurations, network configurations, databases, database schemas, or agent itself, or tenancy unit data and database backup or restore.

In some embodiments, the method comprises a step 320 of acknowledging the completion of the actual actions.

In some embodiments, the method comprises a step 325 of leaving a marking, wherein the marking is successful if the execution of the updates to all tenancy units are completed successfully, wherein the marking is failed if the execution is failed or timed-out, wherein a signal of error is sent out wherein the marking is failed.

1. A method of managing tenants and tenancy units, comprising:
Receiving a first request from a first requester to create a first tenant;
Creating a first tenancy unit with the first tenant, wherein the first tenant is configured to provision its applications and databases, wherein the first tenancy unit is configured to be a first isolation unit consisting of database, application, database schema, application configuration, for the first tenant;
Receiving at least another request from at least another requester to create at least another tenant;
Creating at least another tenancy unit with the at least another tenant, wherein the at least another tenant is configured to provision its applications and databases, wherein the at least another tenancy unit is configured to be at least another isolation unit consisting of database, application, database schema, application configuration, network configuration, for the at least another tenant; wherein the first tenancy unit and the at least another tenancy run the same application, same database schema, and same application configuration template, wherein all tenants comprise the first tenant and the at least another tenant, wherein all tenancy units comprises the first tenancy unit and the at least another tenancy unit;
Receiving a request from a third requester to update the first tenant and the at least another tenant;
Instructing all tenancy units to use a new version of application, application configuration, network configuration, database schema, or tenancy unit data and database backup or restore, or perform other instructions;
Receiving a request from a fourth requester to delete a certain tenant of all tenants, wherein the certain tenant has a certain tenancy unit; and
Deleting the certain tenancy unit for the certain tenant.

2. A method of coordinating application and database updates for multi-tenancy units of all tenants, comprising:
Defining tenant deployment schedule and strategy for development cycles of the all tenants, wherein any of the development cycles is consisting of any combination of a set of environments: development, sandbox, testing, integration, staging, canary and production;
receiving a request from a requester to update applications and databases for the deployment cycles;
instructing the multi-tenancy units to follow the defined deployment schedule and strategy, wherein the defined deployment and strategy includes updating the multi-tenancy units in the order of the development cycles;
checking versions of the all tenants to make sure before a new update is started, there should be no existing update and all tenancy units should have same version;
flagging an unexpected failure, if more than one version exist for the all tenants when there is no update, or no more than two versions of tenancy units exist when an update is being executed to the all tenants; and
pausing and rolling back updates to all tenants when the unexpected failure occurs.

3. A method of managing and updating tenancy units in a multi-tenancy hybrid-cloud or on-premises environment, comprising:
running a service agent application in each tenancy unit of all tenancy units, wherein the service agent application is configured to connect or perform actual actions to the applications or databases in a multi-tenancy hybrid-cloud or on-premises environment;
publishing instruction messages to the all tenancy units by a management service, wherein the instruction messages are not sent to the all tenancy units via network directly, wherein the instruction messages are queued for the service agent application to query, wherein the service agent application is configured to connect to the management service and receive instruction messages asynchronously, wherein the updates are received in versioned order;
Performing actual actions on the all tenancy units by the service agent application including updates to applications, application configurations, network configurations, databases, database schemas, or agent itself, or tenancy unit data and database backup or restore;
acknowledging the completion of the actual actions; and
Leaving a marking, wherein the marking is successful if the execution of the updates to all tenancy units are completed successfully, wherein the marking is failed if the execution is failed or timed-out, wherein a signal of error is sent out wherein the marking is failed.
